(19) United States
(12) Patent Application Publication
(10) Pub. No.: US 2010/0085110 A1
(43) Pub. Date: Apr. 8, 2010

(54) Integrated Circuit Active Power Supply Regulation

(75) Inventors: Dong Jiao, Minneapolis, MN (US); Hai Li, Eden Prairie, MN (US); Ran Wang, Irvine, CA (US); Henry F. Huang, Apple Valley, MN (US); Yiran Chen, Eden Prairie, MN (US)

Correspondence Address: Fellers, Snider, Blankenship, Bailey & Tippens, PC;(Seagate Technology LLC), 100 North Broadway, Suite 1700, Oklahoma City, OK, 73102-8820, US

(73) Assignee: Seagate Technology LLC, Scotts Valley, CA (US)

(21) Appl. No.: 12/501,375

(22) Filed: Jul. 10, 2009

Related U.S. Application Data
(60) Provisional application No. 61/103,738, filed on Oct. 8, 2008.

(51) Int. Cl. G05F 1/10

(52) U.S. Cl. 327/536; 327/538

(57) ABSTRACT

Method and apparatus for compensating for voltage fluctuations on a voltage supply line in an integrated circuit device. In accordance with some embodiments, the apparatus includes a voltage fluctuation sensor which senses a voltage on the supply line, and a compensation circuit comprising a switch and a charge storage device (CSD). The switch actively connects the CSD to the supply line when the voltage sensed by the voltage fluctuation sensor passes outside a predetermined voltage range.

### RELATED APPLICATIONS

This application makes a claim of domestic priority under 35 U.S.C. §119(e) to U.S. Provisional Patent Application No. 61/103,738 filed Oct. 8, 2008.

### BACKGROUND

Power supply regulation can be an important design consideration in modern integrated circuit devices. Designers of such devices often take into account power supply voltage fluctuations, as well as other types of process and component performance variations, in attempting to arrive at a robust system design.

With continued reductions in size of integrated circuit elements, smaller devices and lower power supply voltages are often implemented. Threshold voltage levels, however, do not generally tend to decrease as fast as other main design parameters. For example, some semiconductor memory designs use sense amplifiers to sense relatively small voltage differentials in order to detect data bits stored in memory cells. These voltage differentials can be on the order of about 50-100 millivolts (mv). In these and other applications, power supply voltage fluctuations can adversely affect the ability of such systems to function reliably.

Decoupling capacitance can be added to such designs in an effort to reduce power supply voltage fluctuations. Decoupling capacitance can be implemented by distributing small capacitors throughout the circuit which are permanently installed between various power supply lines and reference lines, such as ground. During operation, each capacitor accumulates charge from the supply line when the voltage overshoots the nominal voltage level, and dumps charge to the supply line when the voltage undershoots the nominal voltage level.

Because the voltage difference between the capacitors and the fluctuating supply voltage can be relatively small, a relatively large number of capacitors may be required to maintain the supply voltage within acceptable voltage fluctuation tolerances. This can increase the cost of the design, in that the capacitors take up overhead space on a semiconductor chip that could be utilized for more valuable functions. Because the capacitors are a permanent feature of the circuitry, the capacitors can also increase the amount of leakage current within the circuit, leading to higher power consumption levels.

### SUMMARY

Various embodiments of the present invention are generally directed to a method and apparatus for compensating for voltage fluctuations on a voltage supply line in an integrated circuit device.

In accordance with some embodiments, the method generally comprises sensing a voltage on the voltage supply line, and using a switch to actively connect a charge storage device (CSD) to the supply line when the sensed voltage passes outside a predetermined voltage range.

In accordance with other embodiments, the apparatus generally comprises a voltage fluctuation sensor configured to sense a voltage on the voltage supply line, and a compensation circuit comprising a switch and a charge storage device (CSD). The switch actively connects the CSD to the supply line when the voltage sensed by the voltage fluctuation sensor passes outside a predetermined voltage range.

These and other features and advantages which characterize the various embodiments of the present invention can be understood in view of the following detailed discussion and the accompanying drawings.

### BRIEF DESCRIPTION OF THE DRAWINGS

FIG. 1 is a generalized functional representation of an exemplary electronic device.

FIG. 2 shows a functional block diagram of an active power supply regulation circuit constructed and operated in accordance with various embodiments of the present invention.

FIG. 3 shows a voltage fluctuation sensor of FIG. 2 in accordance with some embodiments.

FIG. 4 illustrates an overshoot compensation circuit of FIG. 2 in accordance with some embodiments.

FIG. 5 sets forth an undershoot compensation circuit of FIG. 2 in accordance with some embodiments.

FIG. 6 is a charge pump circuit of FIG. 5.

FIG. 7 is a flow chart for an ACTIVE COMPENSATION routine.

### DETAILED DESCRIPTION

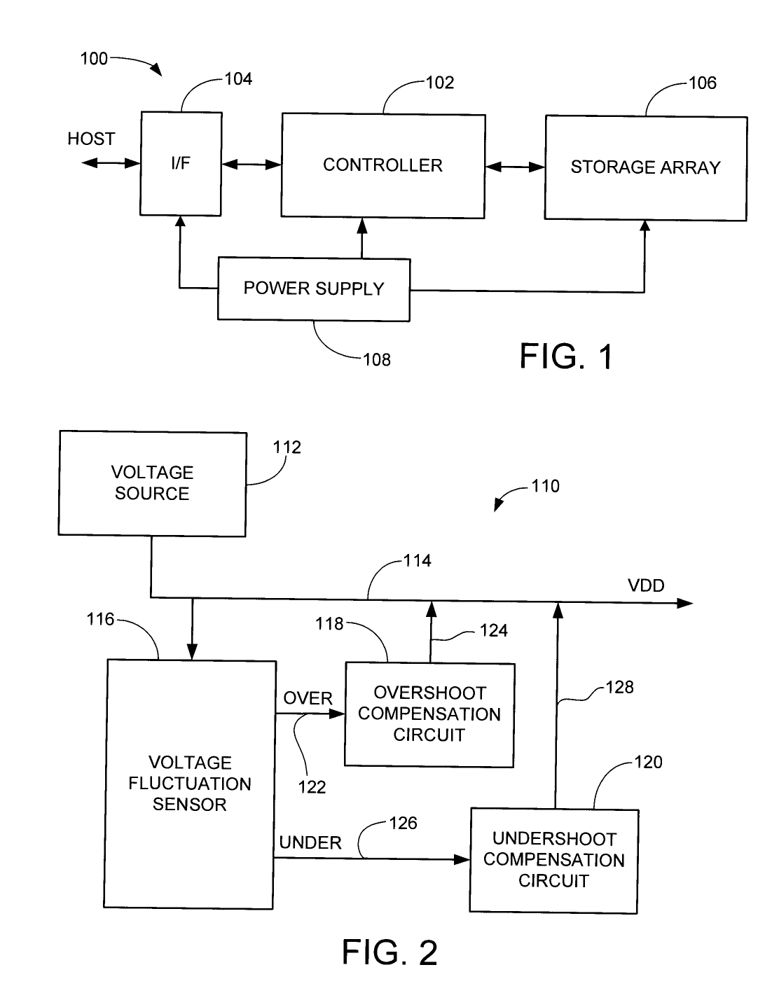

FIG. 1 provides a functional block representation of an integrated circuit electronic device 100. The device 100 is characterized as a data storage device such as a solid-state drive (SSD) used to store user data from a host device. The device 100 is provided to illustrative an exemplary environment in which various embodiments of the present invention can be advantageously practiced. It will be appreciated, however, that the various embodiments disclosed herein can be adapted for use in a number of different types of integrated circuit applications.

The device 100 includes a controller 102 which provides top level control of the device. The controller may be a programmable or hardware based processor. Data I/O operations are carried out using an interface (I/F) circuit 104 which communicates with the host device. Data are transferred between the host device and a data storage array 106. The storage array 106 can comprise an array of volatile or non-volatile memory cells.

A power supply 108 supplies electrical power in the form of various supply voltages to the controller 102, I/F circuit 104 and storage array 106 to facilitate operation of these devices. These supply voltages may be at different nominal voltage levels depending on the requirements of the device, and may be on the order of about +3.0V, ±5.0V, +20.0V, etc. The power supply 108 supplies the electrical power from a separate power source (not shown), such as a battery or a power supply cable from the host device.

FIG. 2 illustrates a functional block diagram for an active power supply regulation circuit 110 in accordance with various embodiments of the present invention. The regulation circuit 110 is shown in conjunction with a voltage source 112 which outputs a supply voltage VDD on a supply voltage line 114. The voltage source 112 may form a portion of the of the power supply 108 of FIG. 1. The regulation circuit 110 can be located as desired among the various circuit elements in FIG. 1. In some embodiments, multiple copies of the regulator circuit 110 are respectively utilized in or with each of the various circuit elements 102, 104 and 106, as required.

As explained below, the regulation circuit 110 operates to detect and compensate for fluctuations in the supply voltage on line 114 in order to maintain the voltage on the line substantially equal to a nominal supply voltage level VDD within some predetermined tolerance range (such as VDD=+3.0V±Δ). The regulation circuit 110 includes a voltage fluctuation sensor 116, an overshoot compensation circuit 118, and an undershoot compensation circuit 120.

The fluctuation sensor 116 detects fluctuations in voltage on the line 114 above (overshoot) and below (undershoot) selected threshold levels. An exemplary voltage threshold range may be ±10% of the nominal line voltage level (e.g., 2.7V to 3.3V), or some other value.

When an overshoot condition is detected (e.g., V_{DETECT}>3.3V), an overshoot signal (OVER) is provided via path 122 to the overshoot compensation circuit 118. In response, the circuit 118 operates to lower the voltage level of the line 114 back within the acceptable voltage range via an active connection 124. Similarly, when an undershoot condition is detected (e.g., V_{DETECT}<2.7V), an undershoot signal (UNDER) is provided via path 126 to the undershoot compensation circuit 120, which in turn operates to raise the voltage level of the line 114 to the acceptable voltage range via an active connection 128.

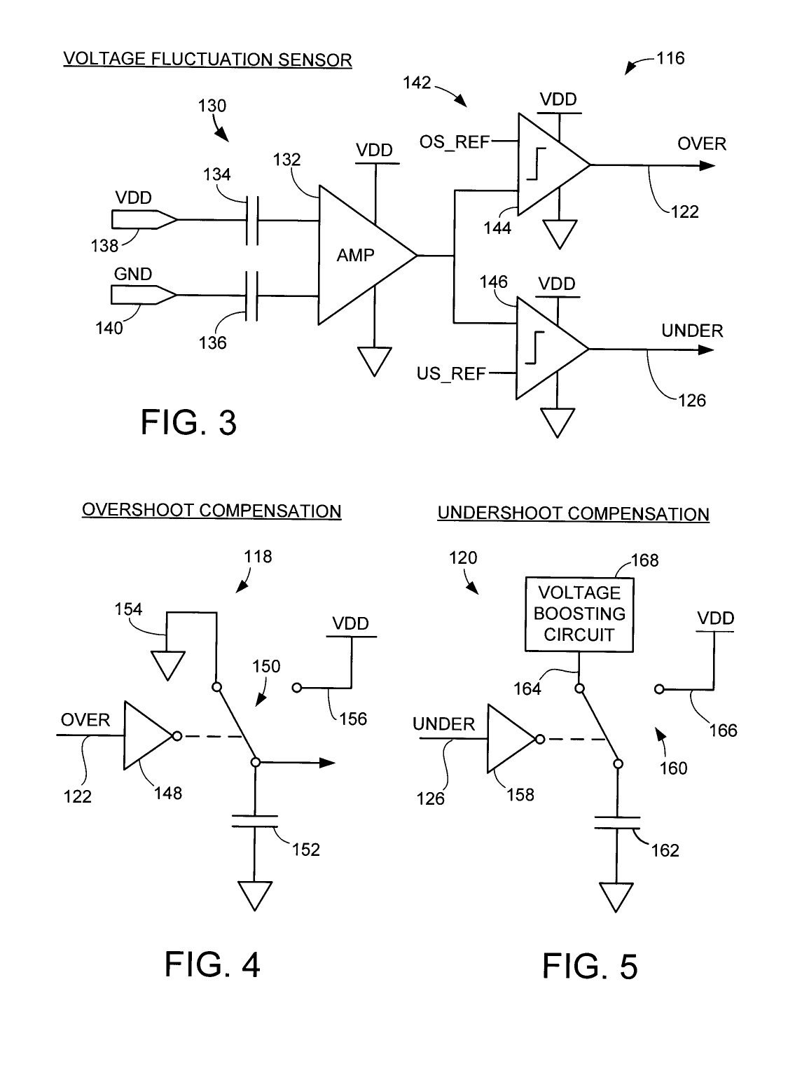

FIG. 3 shows the voltage fluctuation sensor 116 of FIG. 2 in accordance with some embodiments. The sensor 116 includes a capacitively coupled differential amplifier stage 130 with amplifier 132 and respective first and second input capacitors 134, 136. The first capacitor 134 is coupled to an input terminal 138 at the monitored voltage level VDD. The input terminal 138 is coupled to the VDD supply voltage line 114 in FIG. 1. The second capacitor 136 is coupled to an input terminal 140 at a reference level potential (e.g., ground). The capacitors 134, 136 are provided to filter out DC components of the input VDD and GND signals.

The sensor 116 further includes a comparator stage 142 with respective first and second comparators 144, 146 which operate as 1-bit analog-to-digital converters (ADCs). A first reference voltage is supplied to the first comparator 144 characterized as an overshoot reference input, or OS_REF. A second reference voltage is supplied to the second comparator 146 characterized as an undershoot reference input, or US_REF. The outputs of the respective comparators 144, 146 provide the OVER and UNDER signals on paths 122 and 126 in FIG. 2.

The amplifier stage 130 operates to amplify noise variations (AC components) appearing on the VDD and GND terminals 138, 140, and supply an amplified signal to the respective comparators 144, 146. The first and second voltage references OS_REF and US_REF are selected at appropriate levels so that, when the noise exceeds the associated threshold, a 1-bit digital signal will be output. That is, the OVER or UNDER output will transition to a selected logical state, such as high (logical 1). The magnitudes of the voltage references and the gain of the differential amplifier can be empirically determined to provide the requisite threshold range about the nominal VDD voltage.

FIG. 4 shows the overshoot compensation circuit 118 of FIG. 2 in accordance with some embodiments. The circuit 118 includes an inverter 148, a switching device (switch) 150 and a charge storage device (decoupling capacitor) 152. The switching device can take any number of forms, including but not limited to a metal oxide semiconductor field effect transistor (MOSFET) or a programmable memory storage element such as a programmable metallization cell (PMC).

The switching device 150 respectively connects the capacitor 152 between a ground terminal 154 connected to electrical ground (or other reference utilized at 140 in FIG. 3), and a supply line terminal 156 connected to the supply line 114. As shown in FIG. 4, the capacitor 152 is normally connected to ground, and thus is normally not operationally connected to the supply line 114.

When the OVER signal on path 122 transitions high, the inverter 148 inverts this signal to provide an input to the switching device 150, which actively connects the capacitor 152 to the VDD supply line terminal 156. The capacitor 152 will be in an initial non-charged state, and so will begin to accumulate charge from the VDD supply line 114, thereby lowering the voltage of the supply line.

The switching device 150 will continue to actively maintain the capacitor 152 coupled to the supply line until the amplified noise signal from the differential stage 130 (FIG. 3) falls below the OS_REF threshold. At this point, the OVER output signal on path 122 will transition to a different logical state (e.g., logical 0). This state will be inverted by the inverter 148 to disconnect the capacitor 152 from the supply line terminal 156.

The undershoot compensation circuit 120 of FIG. 2 is shown in FIG. 5. As before, the circuit 120 includes an inverter 158, switching device 160, decoupling capacitor 162 and respective selection terminals 164, 166. The capacitor 162 is normally connected via the switching device 160 to a voltage (charge) boosting circuit 168, which places the capacitor 162 in a precharged state.

When the UNDER signal on path 128 is asserted high, the inverter 162 signals the switching device 160 to actively connect the precharged capacitor 162 to the terminal 166, which is coupled to the voltage supply line 114. The prestored charge on the capacitor 162 from the voltage boosting circuit 168 is transferred to the supply line 114 in relation to the differential voltage between the capacitor and the line. This state will continue until the sensed voltage on the supply line 114 exceeds the US_REF threshold, FIG. 3, at which point the switching device 160 will disconnect the capacitor 162 from the supply line terminal 166 and reconnect the capacitor 162 to the voltage boosting circuit 168.

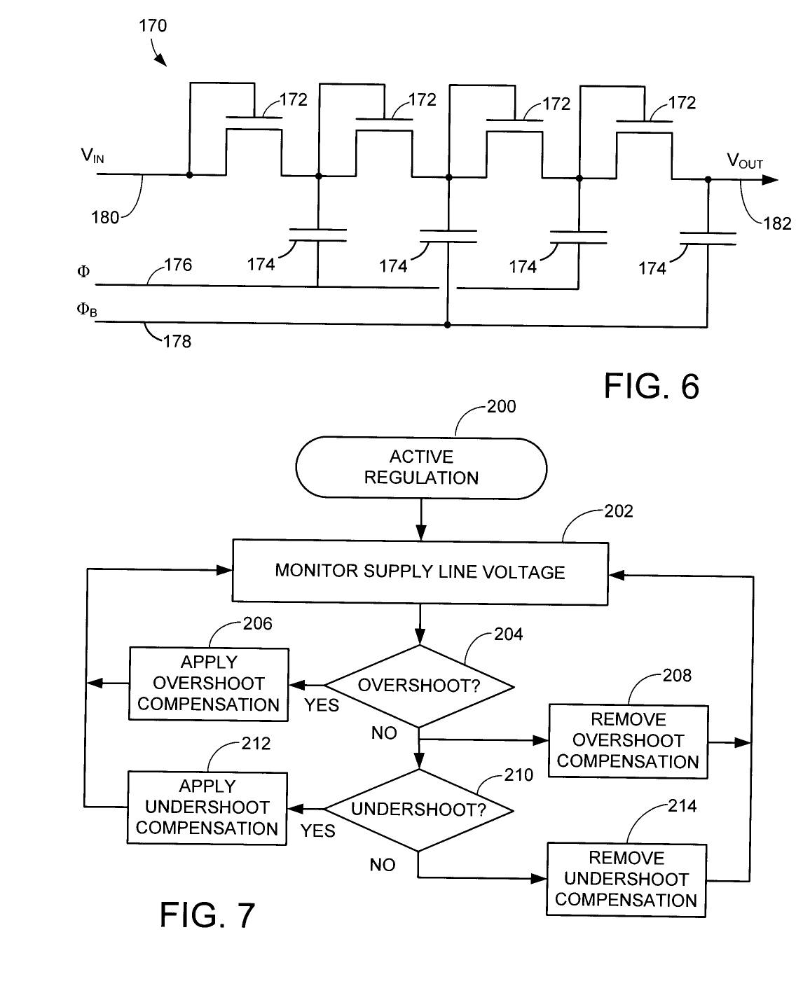

In some embodiments, the voltage boosting circuit 168 of FIG. 5 is configured to charge the capacitor 162 to a voltage that is greater than the supply line voltage VDD, such as 2VDD or higher. FIG. 6 shows a charge pump circuit 170 that can be incorporated into the voltage boosting circuit 168 in some embodiments.

The charge pump circuit 170 is configured as a Dickson charge pump and includes serially connected switching devices 172 respectively connected to charging capacitors 174. The switching devices can be n-channel MOSFETS or can take some other form, such as static charge transfer switches. Time-varying clock inputs Φ and Φ_{B} are supplied on paths 176, 178 and are 180 degrees out of phase. An input voltage V_{IN}, such as V_{DD}, is supplied on line 180 and a voltage V_{OUT} is output on line 182. Generally, V_{OUT} will be greater than V_{IN} (V_{OUT}>V_{IN}), and may be characterized as:

$${V}_{OUT} = {V}_{IN} + N [ \frac{C}{( C + {C}_{S} )} {V}_{Φ} - {V}_{TN} - \frac{{I}_{OUT}}{( C + {C}_{S} ) {f}_{OSC}} ] - {V}_{TN} \qquad ( 1 )$$

where N is the number of stages (in this case, 4), C is the capacitance of each of the capacitors 174, C_{S} is a measure of stray capacitance associated with the MOSFETs 172, V_{Φ}is the voltage magnitude of the input clock signals, I_{OUT} is the output current, f_{OSC} is the frequency of the input clock signals, and V_{TN} is the CMOS threshold voltage of the MOSFETs. Variations to the circuitry in FIG. 6 can be readily incorporated, and a variety of alternative configurations can be used to provide the voltage for the boosting circuit 168.

FIG. 7 provides a flow chart for an ACTIVE REGULATION routine 200, generally illustrative of steps carried out in accordance with the foregoing discussion. Upon activation of the regulation circuit 110 at step 202, the circuit initiates monitoring of the supply line voltage 114 to sense fluctuations in voltage above or below a specified threshold range. This monitoring is continuously applied during operation of the circuit 110 and is carried out in accordance with the sense circuit 116 of FIG. 3.

Decision step 204 queries whether an overshoot condition has been detected; if so, overshoot compensation is applied at step 206 as set forth in FIG. 4. As set forth above, the decap capacitor 152 is switched in and accumulates charge from the supply line 114. This operation continues until the overshoot condition is resolved, after which the overshoot compensation is removed at step 208.

Decision step 210 in FIG. 7 queries whether an undershoot condition has been detected; if so, undershoot compensation is applied at step 212 by the dumping of charge to the supply line 114 from the precharged capacitor 162. This state is maintained until the undershoot condition has been resolved, after which the undershoot compensation is removed at step 214.

In this way, the active regulation circuit 110 initiates and maintains compensation of both overshoot and undershoot conditions in a closed-loop fashion until the fluctuations in the supply line voltage are returned to the specified threshold range.

A straightforward analysis shows that the amount of charge provided by the active operation of FIG. 4 will be about C*VDD, where C is the capacitance of the capacitor 152 and VDD is the nominal voltage of the supply line 114. By contrast, leaving the capacitor 152 continuously coupled to the supply line would only accumulate an amount of charge of about C*ΔV, where ΔV represents the difference between the nominal and actual voltage on the supply line 114 (such as on the order of about 10%, so that VDD=10ΔV). Thus, the area allocated for the capacitor 152 can be reduced by a factor of about 10× due to the active decoupling provided herein. It is contemplated that similar size reductions can be provided for the charge dumping capacitor 162 of FIG. 5 through the use of higher precharge voltages such as discussed in FIG. 6.

Further advantages of the various embodiments illustrated herein include reduced areal overhead through the elimination of permanently connected, passive decoupling capacitors as used in the prior art. The active regulation provides reduced variation in supply voltage levels over prior art approaches, leading to improved performance and device reliability. It will be appreciated that the various embodiments discussed herein have numerous potential applications and are not limited to a certain field of electronic media or type of data storage devices.

While both overshoot and undershoot compensation blocks (see 118, 120 in FIG. 2) have been exemplified herein, it will be appreciated that either one or both can be utilized as desired. Moreover, multiple stages of overshoot and/or undershoot compensation can be switched in for different threshold ranges; for example, a first set of the blocks 118, 120 can operate when the voltage exceeds a first range such as ±10%, a second set of adjacent blocks 118, 120 (with same or different capacitances) can be further switched in if the voltage passes outside of a second range such as ±20%, and so on. In this way, appropriate amounts of charge can be actively accumulated or dumped as required depending on the operational conditions.

The use of digital logic such as the DAC and inverter combinations 134/148 and 136/158, provides hysteresis control and noise rejection stability to the control loop. Other control mechanisms can readily be used, however, including other combinations of logical gates. Various other types of charge storage devices (CSDs) can be used to respectively accumulate and dump charge to the supply lines apart from the discrete semiconductor transistors disclosed herein, including capacitive charge planes, inductors, etc.

It will be further appreciated that the regulation circuit 110 operates in accordance with the various embodiments to augment the voltage being generated by the voltage source 112, and not to serve as a substitute therefor such as in the case of a power shutdown operation. However, in further embodiments it is contemplated that circuitry as embodied herein could be used to detect larger changes in voltage, such as −30% of VDD (0.7VDD), and to switch in the addition of charge to signal and initiate a short term recovery operation, such as the transfer of data from a volatile memory location to a non-volatile memory location before the supply voltage reaches a level (such as zero volts) where further device operation is inhibited.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed.

What is claimed is:

1. A method comprising:
sensing a voltage on a voltage supply line in an integrated circuit; and
using a switch to actively connect a charge storage device (CSD) to the supply line when the sensed voltage transitions beyond a predetermined voltage range.

2. The method of claim 1, further comprising a step of subsequently using the switch to disconnect the CSD from the supply line when the voltage subsequently returns to within the predetermined voltage range.

3. The method of claim 1, wherein the using step comprises accumulating charge from the supply line on the CSD when the CSD is actively connected to the supply line by the switch to compensate for an overshoot condition.

4. The method of claim 1, wherein the using step comprises transferring prestored charge from the CSD to the supply line when the CSD is actively connected to the supply line by the switch to compensate for an undershoot condition.

5. The method of claim 4, further comprising a step of providing a voltage boosting circuit which supplies a boosting voltage that is at least about twice the voltage on the supply line, wherein the boosting voltage supplies the prestored charge on the CSD prior to said active connection of the CSD to the supply line during the using step.

6. The method of claim 1, wherein the sensing step comprises using a differential amplifier which outputs an amplified AC component of the voltage on said supply line, and a comparator which compares said amplified AC component to a reference voltage threshold.

7. The method of claim 6, wherein the comparator is characterized as an analog-to-digital converter (ADC) which outputs a digital signal in response to said comparison, and wherein the switch of the compensation circuit is moved from a first position to a second position responsive to the output digital signal.

8. The method of claim 7, wherein the digital signal has a first logical state when the amplified AC component is greater than the reference voltage threshold, and wherein the digital signal has a second logical state when the amplified AC component is less than the reference voltage threshold, wherein the switch is moved to a selected one of the first or second positions responsive to the first logical state, and wherein the switch is moved to a remaining one of the first or second positions responsive to the second logical state.

9. The method of claim 1, wherein the voltage on the voltage supply line has a nominal voltage level of about +20.0V or lower.

10. The method of claim 1, wherein the switch of the using step is characterized as a metal oxide semiconductor field effect transistor (MOSFET), and wherein the CSD of the using step is characterized as a semiconductor capacitor.

11. An apparatus comprising:
a voltage fluctuation sensor configured to sense a voltage on a voltage supply line in an integrated circuit; and
a compensation circuit comprising a switch and a charge storage device (CSD), wherein the switch actively connects the CSD to the supply line when the voltage sensed by the voltage fluctuation sensor transitions beyond a predetermined voltage range.

12. The apparatus of claim 11, wherein the switch of the compensation circuit subsequently disconnects the CSD from the supply line when the voltage subsequently returns to within the predetermined voltage range to compensate for an overshoot condition.

13. The apparatus of claim 11, wherein the compensation circuit is characterized as an overshoot compensation circuit and wherein the CSD accumulates charge from the supply line when actively connected thereto by the switch to compensate for an undershoot condition.

14. The apparatus of claim 11, wherein the compensation circuit is characterized as an undershoot compensation circuit and wherein the CSD transfers prestored charge to the supply line when actively connected thereto by the switch.

15. The apparatus of claim 14, wherein the undershoot compensation circuit further comprises a voltage boosting circuit which supplies a boosting voltage that is at least about twice the voltage on the supply line, and wherein the boosting voltage supplies the prestored charge on the CSD prior to said active connection of the CSD to the supply line by the switch.

16. The apparatus of claim 11, wherein the switch and the CSD are respectively characterized as a first switch and a first CSD, and wherein the compensation circuit comprises:
an overshoot compensation circuit comprising the first switch and the first CSD, wherein the first CSD is actively connected to the supply line by the first switch responsive to the voltage on the supply line exceeding an upper threshold, and wherein the first CSD accumulates charge from the supply line to bring the voltage thereon below the upper threshold; and
an undershoot compensation circuit comprising a second switch and a second CSD, wherein the second CSD is actively connected to the supply line by the second switch responsive to the voltage on the supply line falling below a lower threshold, and wherein the second CSD dumps prestored charge to the supply line to bring the voltage thereon above the lower threshold.

17. The apparatus of claim 11, wherein the voltage fluctuation sensor comprises a differential amplifier which outputs an amplified AC component of the voltage on said supply line, and a comparator which compares said amplified AC component to a reference voltage threshold.

18. The apparatus of claim 17, wherein the comparator is characterized as an analog-to-digital converter (ADC) which outputs a digital signal in response to said comparison, and wherein the switch of the compensation circuit is moved from a first position to a second position responsive to the output digital signal.

19. The apparatus of claim 18, wherein the digital signal has a first logical state when the amplified AC component is greater than the reference voltage threshold, and wherein the digital signal has a second logical state when the amplified AC component is less than the reference voltage threshold, wherein the switch is moved to a selected one of the first or second positions responsive to the first logical state, and wherein the switch is moved to a remaining one of the first or second positions responsive to the second logical state.

20. The apparatus of claim 1, wherein the switch is characterized as a metal oxide semiconductor field effect transistor (MOSFET), and wherein the CSD is characterized as a semiconductor capacitor.
